(19) United States
(12) Patent Application Publication
(10) Pub. No.: US 2013/0231037 A1
(43) Pub. Date: Sep. 5, 2013

(54) INTAKE STRUCTURE OF EXTERNAL AIR FOR VEHICLE

(71) Applicant: Dong Won Yeon, Hwaseong-si (KR)

(72) Inventor: Dong Won Yeon, Hwaseong-si (KR)

(73) Assignee: Hyundai Motor Company, Seoul (KR)

(21) Appl. No.: 13/601,316

(22) Filed: Aug. 31, 2012

(30) Foreign Application Priority Data
Mar. 5, 2012 (KR) 10-2012-0022119

(51) Int. Cl. B60H 1/28

(52) U.S. Cl. 454/146

(57) ABSTRACT

An intake structure of external air for a vehicle may include a car body panel connected to a cowl top cover at an upper end thereof, wherein an external air intake space may be formed in a width direction of the vehicle between the car body panel and the cowl top cover, and wherein the car body panel guides the external air flowing into the external air intake space from the cowl top cover to an interior of the vehicle, a separator covering an engine to form an engine compartment therein, wherein the separator has a center portion blocking a front of the external air intake space from the engine compartment, and a shield panel that may be connected to the separator to block the engine compartment from the external air intake space together with the separator.

### CROSS-REFERENCE TO RELATED APPLICATION

The present application claims priority to Korean Patent Application No. 10-2012-0022119, filed on Mar. 05, 2012, the entire contents of which is incorporated herein for all purposes by this reference.

### BACKGROUND OF THE INVENTION

1. Field of the Invention

The present disclosure relates to an intake structure of external air for a vehicle which allows air to flow into the interior of the vehicle by using a panel and a separator without using a separate duct.

2. Description of Related Art

In general, when a driver drives a vehicle with the inside sealed, the interior of the vehicle becomes lack of oxygen and the driver may doze at the wheel. Therefore, it is necessary to circulate the air in the vehicle by periodically opening the windows or operate the air-conditioning system of the vehicle in an external air mode such that external air flows and circulates in the vehicle.

As described above, the ventilation structure of a vehicle is a very important part for improvement of pleasantness of the interior and safe driving, and implemented such that external air flows into a vehicle through the cowl of the vehicle while the vehicle travels. That is, as a vehicle is driven, pressure is applied to the windshield glass and is transmitted to the interior through the panel structure under the cowl top cover.

This structure allows external air to flow inside by using an intake structure that uses a separate air intake duct when the engine compartment is equipped with a separation wall.

For reference, FIG. 1 shows an intake structure of external air of the related art, that is, a structure for external air flowing inside through an intake duct, in which a cowl top cover (not shown) is disposed at the lower end of a windshield glass and an air intake duct 1 is disposed under the cowl top cover such that the air flowing inside through the cowl top cover can flow into the interior. Further, an intake 2 that communicates with the interior of the vehicle is formed at the air intake duct 1 so that the air flowing inside through the cowl top cover can flows into the interior of the vehicle through the air intake duct 1.

However, in the intake structure of external air according to the related art, it is necessary to make the other portion, except for an opening at the upper end and the intake, cover the internal space in a hull shape in order to prevent the air flowing into the air intake duct from leaking outside so that the cost of materials for forming the air intake duct and the manufacturing cost are relatively increased.

In particular, since the air intake duct is disposed at the front of the car body panel, it is necessary to prepare a separate space for disposing the air intake duct in the engine compartment so that the spatial efficiency of the inside of the engine compartment is decreased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an intake structure of external air for vehicle which allows external air to flow into the interior of a vehicle by using a vehicle panel and a separator without using a separate duct.

In an aspect of the present invention, an intake structure of external air for a vehicle, may include a car body panel connected to a cowl top cover at an upper end thereof, wherein an external air intake space is formed in a width direction of the vehicle between the car body panel and the cowl top cover, and wherein the car body panel guides the external air flowing into the external air intake space from the cowl top cover to an interior of the vehicle, a separator covering an engine to form an engine compartment therein, wherein the separator may have a center portion blocking a front of the external air intake space from the engine compartment, and a shield panel that is connected to the separator to block the engine compartment from the external air intake space together with the separator.

An upper end of the shield panel is connected to the cowl top cover, a lower end thereof is connected to the car body panel, and a side thereof is connected to the separator to enclose the engine to block the engine compartment from the external air intake space.

The shield panel is hermetically combined with the cowl top cover, the car body panel, and the separator.

An extender that extends toward the separator is formed at a side of the shield panel, an end of the extender is connected to the separator, and the other end of the extender is connected to the car body panel, so that the extender is finished between the separator and the car body panel.

A distal end of the extender bends at an angle corresponding to the separator and is hermetically combined with the separator.

A blocking panel is disposed to block the external air intake space in order to prevent the external air from leaking through sides of the external air intake space.

The blocking panel is disposed at a lateral end of the extender of the shield panel in the width direction of the vehicle and hermetically fixed to the car body panel, the shield panel, and the separator.

The center portion of the separator is formed in the width direction to be opposite the car body panel and blocks the front of the external air intake space.

An intake that fluid-communicates with an air conditioner is formed at the car body panel so that the external air flowing in the external air intake space flows into the interior of the vehicle through the intake.

The separator is sealed to a hood panel.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing a structure for allowing external air to flow inside by using an air intake duct in the related art.

FIG. 2 is a view showing a structure when a cowl top cover is assembled in an intake structure of external air according to an exemplary embodiment of the present invention.

FIG. 3 is a cross-sectional view taken along line A-A of FIG. 2.

FIG. 4 is a cross-sectional view taken along line B-B of FIG. 2.

FIG. 5 is a view showing a connection structure of for a shield panel and a separator in an intake structure of external air according to an exemplary embodiment of the present invention.

FIG. 6 is a view showing the shapes of a shield panel and a blocking panel according to an exemplary embodiment of the present invention.

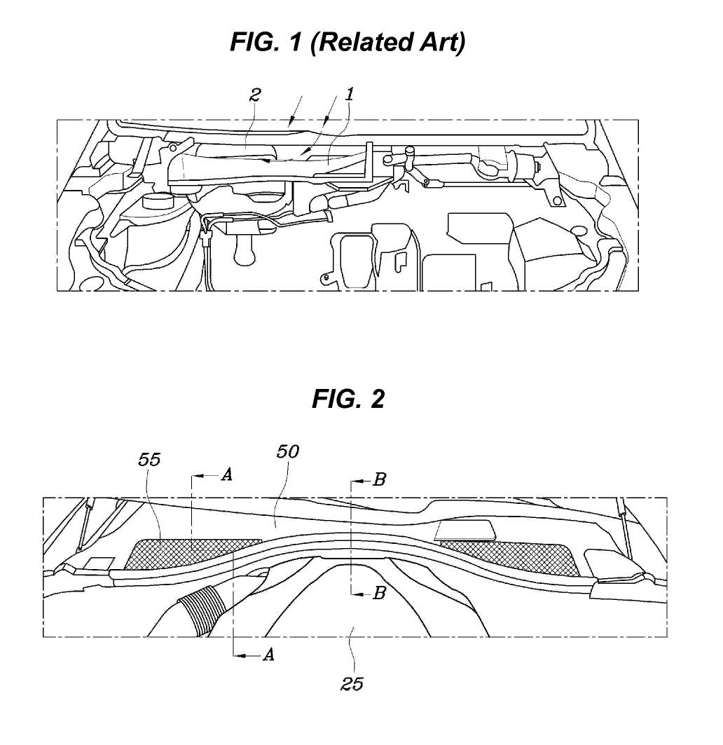

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

Preferred embodiments of the present invention are described hereafter in detail with the accompanying drawings.

An intake structure of external air for a vehicle according to an exemplary embodiment of the present invention which is shown in FIGS. 2 to 6 may largely include a car body panel 10, a separator 20, and a shield panel 30.

As shown in FIGS. 2 to 4, the car body panel 10 is disposed between an engine compartment and the interior of a vehicle to separate the interior from the engine compartment and may be a dash panel. The car body panel 10 is connected with the rear end of a cowl top cover 50, with the upper end positioned at the lower end of a windshield glass W, and has an external air intake space 12 defined in the width direction of the vehicle at the front.

The cowl top cover 50 is provided with a grill 55 such that air hitting against the windshield glass W flows into the external air intake space 12 through the grill 55 of the cowl top cover 50, thereby guiding external air into the interior of the vehicle.

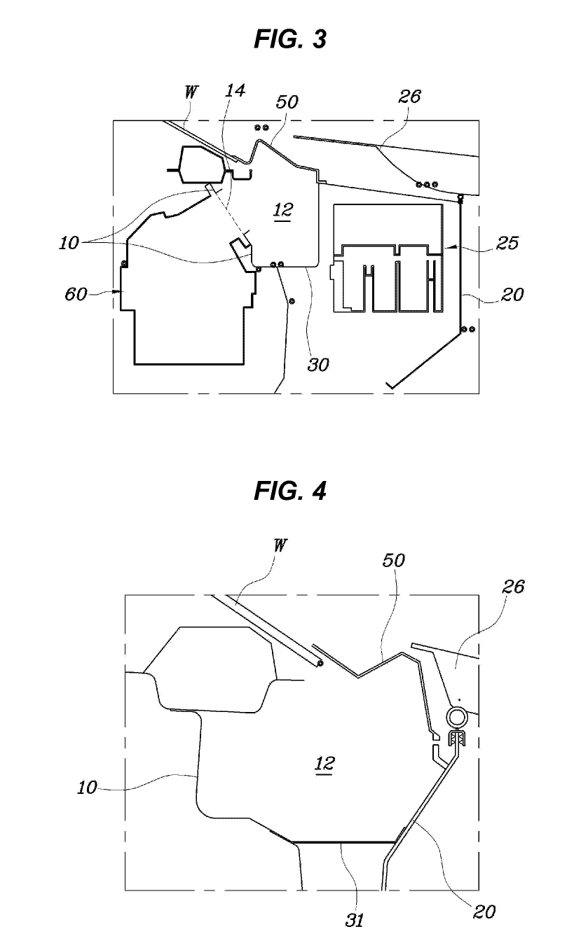

As shown in FIGS. 3 to 5, the separator 20 is disposed between the car body panel 10 and the engine 25 for shielding so that it prevents contaminated external air in the engine compartment from flowing into the interior of the vehicle. The separator 20 may be sealed to a hood panel 26 at the upper end by a weather strip.

Further, both ends of the center portion of the separator 20 bend such that the separator 20 surrounds an engine 25.

In particular, the center portion of the separator 20 blocks the front center portion of the external air intake space 12 defined at the front end of the car body panel 10 so that it can cover the center portion of the external air intake space 12 from the front.

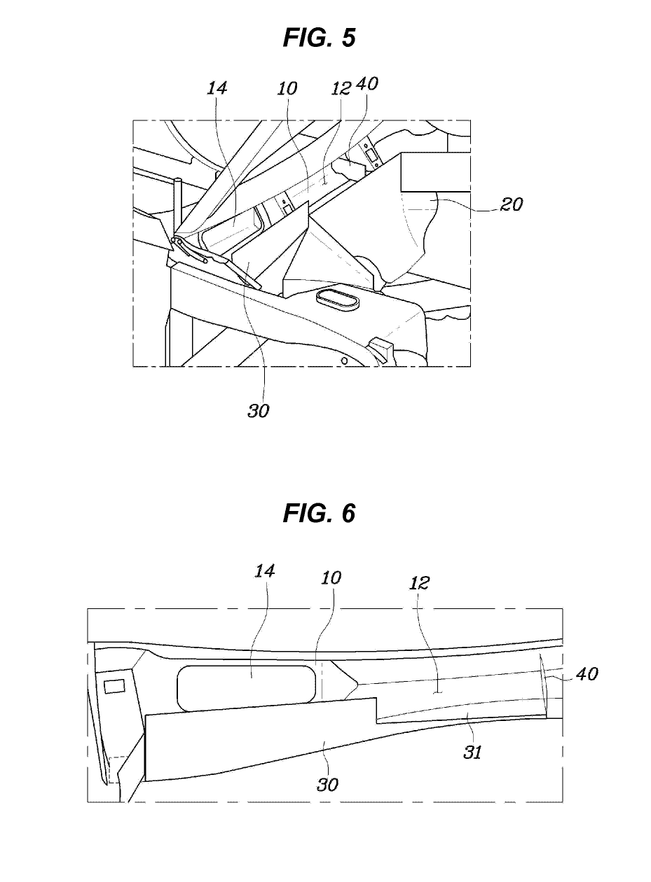

As shown in FIGS. 5 and 6, the car body panel 10 blocks the front of one side of the external air intake space 12 which is not blocked by the separator 20 and the car body panel 10 is connected to one end of the center portion of the separator 20 so that it covers the side of the external air intake space 12 at the front, and accordingly, the external air intake space 12 can be shielded together with the separator 20.

Further, as shown in FIG. 3, the upper end of the shield panel 30 is connected to the cowl top cover 50, the lower end is connected to the car body panel 10, and one side is connected to the separator 20 such that the external air intake space 12 is shielded.

That is, the upper end of the shield panel 30 is connected with the front of the cowl top cover 50, the lower end of the shield panel 30 is connected to the car body panel 10 positioned at the lower end of the external air intake space 12, and one side of the shield panel 30 is connected with the separator 20 so that the external air intake space 12 can be covered by the shield panel 30 and the separator 20.

In an exemplary embodiment of the present invention, the shield panel 30 may be hermetically combined with the cowl top cover 50, the car body panel 10, and the separator 20. That is, the parts connected with the shield panel 30 are sealed and matched so that the air flowing in the external air intake space 12 can be guided to flow into the interior of the vehicle, not leaking outside.

Common sealing methods may be used for the sealing and a sealing method using a bonding means may be used.

In an exemplary embodiment of the present invention, as shown in FIGS. 5 and 6, an extender 31 that extends toward the separator 20 is formed at one side of the shield panel 30, one end of the extender 31 is connected to the separator 20, and the other end of the extender 31 is connected to the car body panel 10 so that the extender 31 can be finished between the separator 20 and the car body panel 10.

That is, the center portion of the separator 20 that blocks the center portion of the external air intake space 12 is formed in a flat surface with a predetermined angle so that the car body panel 10 and the separator 20 can be separated. Therefore, the lower end of the shield panel 30 extends toward a side, that is, the separator 20 and the extender 31 blocks the lower center portion of the external air intake space 12 so that the external air intake space 12 is easily and simply shielded.

As shown in FIG. 4, the extender 31 may be hermetically connected to the separator by bending one end thereof to have an angle corresponding to the separator 20. That is, the front end of the extender 31 which is connected with the separator 20 bends and the bending front end is overlapped with the separator 20 so that the portion between the extender 31 and the separator 20 can be simply and stably sealed.

According to an exemplary embodiment of the present invention, a blocking panel 40 is disposed to block the external air intake space 12 so that it is possible to prevent air from leaking through sides of the external air intake space 12.

Further, the blocking panel 40 is disposed at the end of the extender 31 of the shield panel 30 and may be hermetically fixed to the car body panel 10, the shield panel 30, and the separator 20.

That is, the blocking panel 40 is disposed in the front-rear direction of the vehicle, at the end of the external air intake space 12 covered by the separator 20 and the extender 31 to cover one side of the external air intake space 12 so that it is possible to prevent the air flowing into the external air intake space 12 from leaking through the sides of the external air intake space 12.

The edges of the car body panel 10, the shield panel 30, and the separator 20 connected with the blocking panel 40 is sealed such that external air is further prevented from leaking.

According to an exemplary embodiment of the present invention, the center portion of the separator 20 is formed in the width direction to be opposite the car body panel 10 in order to block the front of the external air intake space 12. That is, the center portion of the separator 20 that blocks the front center portion of the external air intake space 12 is formed in a flat surface shape in the width direction so that the front of the external air intake space 12 is more effectively covered.

The center portion of the separator 20 may be vertically formed, and preferably, the upper end of the separator 20 may be inclined forward.

According to an exemplary embodiment of the present invention, an intake 14 that communicates with an air conditioner 60 is formed at the car body panel 10 so that the air flowing in the external air intake space 12 can flow into the interior of the vehicle through the intake 14. That is, the intake 14 is formed at the car body panel 10 to communicate with the external air intake space 12 and communicate with the air conditioner 60 so that the external air flowing in the external air intake space 12 can flow into the interior of the vehicle through the air conditioner 60.

The operation and effect of the present invention are described in detail with reference to FIGS. 4 and 5.

When the air-conditioning system of a vehicle operates in an external air mode and wind hits against the windshield glass W, the external air flows into the external air intake space 12 through the grill 55 of the cowl top cover 50.

The external air intake space 12 is shield by the separator 20, the shield panel 30, and the blocking panel 40 so that most of the external air flowing in the external air intake space 12 flows into the air conditioner 60 through the intake 14 and the air flowing in the air conditioner 60 flows into the interior of the vehicle so that the driver can achieve a desired air-conditioning function.

According to an exemplary embodiment of the present invention, as described above, the external air intake space 12 is shielded by the assembly of the separator 20 and the shield panel 30 and the air flowing in the external air intake space 12 flows into the interior of the vehicle.

Therefore, it is possible to allow external air to flow into the interior without disposing a separate air intake duct so that there is no need to prepare a separate space for disposing an air intake duct, therefore, it is possible to improve spatial usability and the degree of freedom in design of the internal space of the engine compartment to improve the layout of the engine compartment.

Further, since the separator 20 that prevents air from flowing into the engine compartment by covering and shielding the external air intake space 12 is used, the number of parts for covering the external air intake space 12 is reduced so that the intake structure can be minimized and the manufacturing cost of the intake structure of external air can be reduced.

According to an exemplary embodiment of the present invention, the external air intake space is shielded by the assembly of the separator and the shield panel, such that it is possible to reduce a space for disposing an air intake duct, therefore, it is possible to improve spatial usability and the degree of freedom in design of the internal space of the engine compartment, such that it is possible to improve the layout of the engine compartment, such that it is possible to improve the layout of the engine compartment.

Further, since the external air intake space is covered and shielded by the separator that prevents air from flowing into the engine compartment, the number of parts for covering the external air intake space is reduced, such that the intake structure can be minimized and the manufacturing cost of the intake structure of external air can be reduced.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An intake structure of external air for a vehicle, comprising:
a car body panel connected to a cowl top cover at an upper end thereof, wherein an external air intake space is formed in a width direction of the vehicle between the car body panel and the cowl top cover, and wherein the car body panel guides the external air flowing into the external air intake space from the cowl top cover to an interior of the vehicle;
a separator covering an engine to form an engine compartment therein, wherein the separator has a center portion blocking a front of the external air intake space from the engine compartment; and
a shield panel that is connected to the separator to block the engine compartment from the external air intake space together with the separator.

2. The intake structure of claim 1, wherein an upper end of the shield panel is connected to the cowl top cover, a lower end thereof is connected to the car body panel, and a side thereof is connected to the separator to enclose the engine to block the engine compartment from the external air intake space.

3. The intake structure of claim 2, wherein the shield panel is hermetically combined with the cowl top cover, the car body panel, and the separator.

4. The intake structure of claim 1, wherein an extender that extends toward the separator is formed at a side of the shield panel, an end of the extender is connected to the separator, and the other end of the extender is connected to the car body panel, so that the extender is finished between the separator and the car body panel.

5. The intake structure of claim 4, wherein a distal end of the extender bends at an angle corresponding to the separator and is hermetically combined with the separator.

6. The intake structure of claim 1, wherein a blocking panel is disposed to block the external air intake space in order to prevent the external air from leaking through sides of the external air intake space.

7. The intake structure of claim 6, wherein the blocking panel is disposed at a lateral end of the extender of the shield panel in the width direction of the vehicle and hermetically fixed to the car body panel, the shield panel, and the separator.

8. The intake structure of claim 1, wherein the center portion of the separator is formed in the width direction to be opposite the car body panel and blocks the front of the external air intake space.

9. The intake structure of claim 1, wherein an intake that fluid-communicates with an air conditioner is formed at the car body panel so that the external air flowing in the external air intake space flows into the interior of the vehicle through the intake.

10. The intake structure of claim 1, wherein the separator is sealed to a hood panel.
